(19) United States
(12) Patent Application Publication
(10) Pub. No.: US 2026/0180492 A1
(43) Pub. Date: Jun. 25, 2026

(54) Mid-Clamp for PV Panel Installation

(71) Applicant: Top Rack Technology, Inc., Moorestown, NJ (US)

(72) Inventor: Guohao Zhu, Haining City (CN)

(73) Assignee: Top Rack Technology, Inc., Moorestown, NJ (US)

(21) Appl. No.: 19/089,709

(22) Filed: Mar. 25, 2025

(30) Foreign Application Priority Data
Dec. 19, 2024 (CN) 202423133896.9

(51) Int. Cl. H02S 20/20; F16B 5/06

(52) U.S. Cl. CPC H02S 20/20; F16B 5/0635; F16B 5/0685; F16B 2005/0678

(57) ABSTRACT

The present disclosure relates to a mid-clamp for PV panel installation, comprising an upper pressing block and a fixed connecting block, which are connected using a sleeve-type mechanism. This utility model offers a compact structure, enabling quick and easy PV panel installation with high stability and firm fixation. It provides long service life and incorporates a dual grounding mechanism for enhanced electrical safety.

### TECHNICAL FIELD

The present utility model relates to the field of solar photovoltaic (PV) technology, specifically to a mid-clamp for PV panel installation.

### BACKGROUND TECHNOLOGY

Mid-clamps in PV mounting structures are fixed onto the PV mounting frame using bolts. They serve as connectors between two adjacent PV panels, enhancing the structural stability and wind resistance of the solar power system. As shown in FIG. 7, conventional mid-clamps typically consist of a connecting block (1), an upper pressing block (2), and fastening hardware (3). The upper pressing block (2) has pressing plates symmetrically positioned on both sides, while the fastening hardware (3) secures the upper pressing block (2) to the connecting block (1). However, during PV panel installation, the upper pressing block (2) lacks structural support, leading to lateral wobbling before the bolt is fully tightened. This instability makes panel installation difficult and time-consuming for workers. Additionally, if the bolt loosens over time, it may rotate freely, potentially causing panel displacement or detachment, leading to safety risks.

### SUMMARY OF THE UTILITY MODEL

To address the limitations of existing technology, the present utility model provides a mid-clamp for PV panel installation with a compact structure, enabling quick and easy installation while ensuring high stability, secure fixation, and long service life. Furthermore, a dual grounding mechanism is incorporated for enhanced electrical safety.

### Technical Solution

To achieve the above objectives, the present utility model provides a mid-clamp for PV panel installation, which comprises an upper pressing block and a fixed connecting block, wherein:
A sleeve-type mechanism is used for connection between the upper pressing block and the fixed connecting block.
The upper pressing block includes a PV panel pressing plate and two sleeve rods.
The fixed connecting block is designed with sleeve slots matching the two sleeve rods.
A spring is positioned between the two sleeve rods and secured around the bolt's screw rod, allowing for elastic height adjustment during PV panel installation.
Both the upper pressing block and the fixed connecting block are equipped with grounding pins.

### FURTHER IMPROVEMENTS

1. Supporting Plate: The fixed connecting block incorporates a supporting plate to prevent the mid-clamp from sinking into the rail during installation.
2. Grounding Pin I: The grounding pin on the fixed connecting block comprises a connecting section and a piercing section, and is installed into a matching groove via press-fit fixation.
3. Grounding Pin II: The grounding pin on the upper pressing block is positioned on both sides of the PV panel pressing plate and is installed using an embedded fixation method.

### Advantages of the Utility Model

The sleeve-type connection between the upper pressing block and the fixed connecting block, along with the integrated spring mechanism, allows for automatic height adjustment during PV panel installation.
The compact structure enables quick and easy installation with high stability and secure fixation, significantly reducing installation time.
The dual grounding system enhances electrical conductivity, ensuring reliable electrical grounding:
   Grounding Pin I establishes electrical contact with the rail.
   Grounding Pin II establishes electrical contact with the PV panel.
The supporting plate prevents the mid-clamp from sinking into the rail, improving structural integrity and installation reliability.

This mid-clamp design significantly improves the efficiency, durability, and safety of PV panel installations.

### DESCRIPTION OF DRAWINGS

FIG. 1: Structural schematic diagram of the embodiment of the present utility model.

FIG. 2: Exploded schematic diagram of the embodiment of the present utility model.

FIG. 3: Structural schematic diagram of Grounding Pin I in the embodiment of the present utility model.

FIG. 4: First installation schematic diagram of the embodiment of the present utility model.

FIG. 5: Second installation schematic diagram of the embodiment of the present utility model.

FIG. 6: Schematic diagram of the embodiment after installation.

FIG. 7: Structural schematic diagram of a mid-clamp in the prior art.

### ILLUSTRATION LABELS IN THE DRAWINGS

17—Upper Pressing Block
18—Fixed Connecting Block
19—Bolt
20—Pressing Plate
21—Sleeve Rod
22—Rail
23—Grounding Pin I
24—Grounding Pin II
25—Spring
26—Supporting Plate
27—Connecting Section
28—Piercing Section

### DETAILED DESCRIPTION OF THE EMBODIMENT

The following section, in conjunction with the accompanying drawings, provides a clear and complete description of the technical solutions of the embodiments of the present utility model. It is evident that the described embodiments represent only a portion of the possible implementations of this invention and not all possible embodiments. Based on the disclosed embodiments, any other implementations obtained by those skilled in the field without making creative efforts fall within the scope of the present utility model.

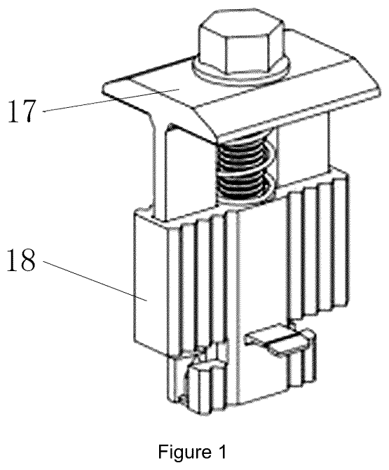

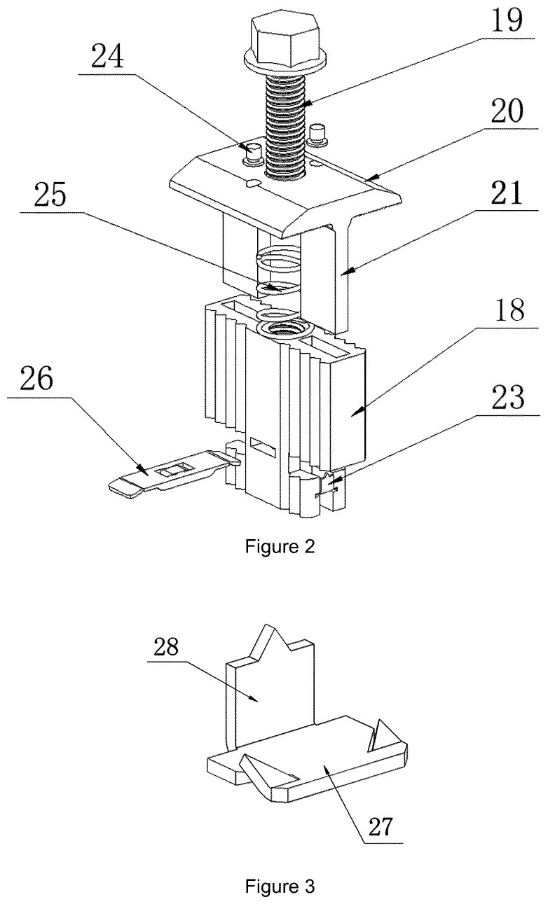

As shown in FIGS. 1 and 2, a mid-clamp for PV panel installation is disclosed, comprising an upper pressing block (17) and a fixed connecting block (18). The upper pressing block (17) and the fixed connecting block (18) are connected using a sleeve-type mechanism.
The upper pressing block (17) includes a PV panel pressing plate (20) and two sleeve rods (21).
The fixed connecting block (18) is designed with sleeve slots matching the two sleeve rods (21).
A spring (25) is positioned between the two sleeve rods (21) and secured around the bolt (19) screw rod, allowing for elastic height adjustment during PV panel installation.
The fixed connecting block (18) also incorporates a supporting plate (26), which prevents the mid clamp from sinking into the rail (22) during installation.
Both the upper pressing block (17) and the fixed connecting block (18) are equipped with grounding pins.

The grounding system is designed to ensure electrical conductivity:
Grounding Pin I (23), attached to the fixed connecting block (18), consists of a connecting section (27) and a piercing section (28) (as shown in FIG. 3). It is installed into a matching groove via press-fit fixation.
Grounding Pin II (24) is positioned on both sides of the PV panel pressing plate (20) and is installed using an embedded fixation method.

### Installation Process

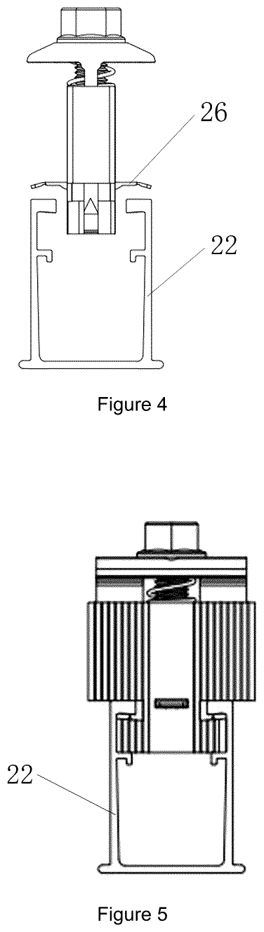

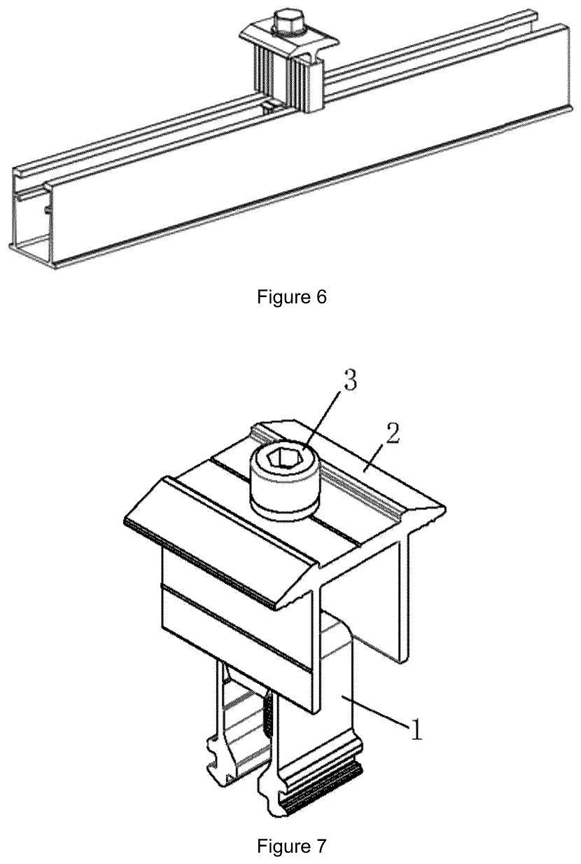

1. Inserting the Mid Clamp into the Rail:
   As illustrated in FIG. 4, the mid clamp is inserted into the installation groove of the rail (22).
   The supporting plate (26) ensures that the mid clamp does not sink into the rail (22).
2. Rotating and Fixing the Mid Clamp:
   The mid clamp is then rotated 90 degrees to secure it in place (as shown in FIG. 5).
   At this point, the piercing section (28) of Grounding Pin I establishes electrical continuity with the rail (22).
3. Final Positioning and Functionality:
   After installation, the mid clamp can still move within the installation groove for minor adjustments (as depicted in FIG. 6).

This mid-clamp design significantly improves the efficiency, durability, and safety of PV panel installations, ensuring secure attachment, structural stability, and reliable grounding.

It will be appreciated by persons skilled in the art that the present invention is not limited to what has been particularly shown and described. Rather, the scope of the present invention is defined by the claims which follow. It should further be understood that the above description is only representative of illustrative examples of embodiments. The description has not attempted to exhaustively enumerate all possible variations. The alternate embodiments may not have been presented for a specific portion of the invention, and may result from a different combination of described portions, or that other un-described alternate embodiments may be available for a portion, is not to be considered a disclaimer of those alternate embodiments. It will be appreciated that many of those un-described embodiments are within the literal scope of the following claims, and others are equivalent.

1. A clamp for PV panel installation, comprising an upper pressing block (17) and a fixed connecting block (18), wherein:
the upper pressing block (17) and the fixed connecting block (18) are connected using a sleeve-type mechanism;
the upper pressing block (17) includes a PV panel pressing plate (20) and two sleeve rods (21);
the fixed connecting block (18) is designed with sleeve slots matching the two sleeve rods (21);
a spring (25) is positioned between the two sleeve rods (21) and secured around bolt screw rod (19), allowing for height adjustment during PV panel installation; and
the upper pressing block (17) and the fixed connecting block (18) are each equipped with grounding pins.

2. The clamp for PV panel installation according to claim 1, wherein the fixed connecting block (18) contains a supporting plate (26).

3. The clamp for PV panel installation according to claim 1, wherein:
grounding Pin I (23) on the fixed connecting block (18) comprises a connecting section (27) and a piercing section (28);
the fixed connecting block (18) is provided with an installation groove matching the connecting section (27), using a press-fit fixation method.

4. The clamp for PV panel installation according to claim 1, wherein Grounding Pin II (24) on the upper pressing block (17) is positioned on both sides of the PV panel pressing plate (20) and is installed using an embedded fixation method.

5. A method of installing the clamp of claim 1, comprising:
(a) inserting the Clamp into a rail; and
(b) rotating the clamp and securing it in the rail.
